(19) United States
(12) Patent Application Publication
(10) Pub. No.: US 2023/0177530 A1
(43) Pub. Date: Jun. 8, 2023

(54) SYSTEM AND METHOD FOR GENERATING MEASURABLE SOCIAL IMPACT

(71) Applicant: OM Guarantee Inc., Shasta Lake, CA (US)

(72) Inventors: Paul Rodney Turner, Wilmington, DE (US); Arlo Vegan, Merlin, OR (US); Adrian Bernard, Queensland (AU)

(21) Appl. No.: 17/890,127

(22) Filed: Aug. 17, 2022

Related U.S. Application Data
(60) Provisional application No. 63/234,032, filed on Aug. 17, 2021.

(51) Int. Cl. G06Q 30/0201; G06Q 30/06; G06Q 30/0226; G06Q 30/018

(52) U.S. Cl. CPC G06Q 30/0201; G06Q 30/06; G06Q 30/0226; G06Q 30/018; G06Q 2220/00

(57) ABSTRACT

A system and method for generating measurable social impact, the system and method comprising tracking a transaction, wherein the transaction comprises a purchase of at least one good or service, wherein the at least one good or service is associated with a social impact partner, and wherein the transaction is captured in a first blockchain record on a first blockchain, collecting a purchase amount of the transaction, sending, to a second computing device, at least a portion of the purchase amount of the transaction, wherein the second computing device is associated with the social impact partner, and tracking, at the server, a receipt of the at least a portion of the purchase amount of the transaction at the second computing device, wherein the receipt is captured in a second blockchain record on the first blockchain.

### CROSS-REFERENCE TO RELATED APPLICATIONS

This application claims the benefit of, and priority to, U.S. Provisional Patent Application No. 63/234,032, filed Aug. 17, 2021, which is incorporated by reference herein in its entirety for all purposes.

### BACKGROUND

A growing number of companies are making corporate social responsibility and giving back to the community a significant part of their brand ethos. According to research done by Mintel, a company's charitable giving affects three-quarters (73%) of Americans' purchase decisions. In 2020 and the foreseeable future, cause marketing does and may continue to translate to sales, with 69% of Gen Z consumers saying they are more likely to buy from a company contributing to charitable causes.

Accordingly, there is a need to provide a system and method for generating measurable social impact that aims to help socially responsible and conscious companies make a positive social impact that is measurable and certified.

### BRIEF SUMMARY

According to one aspect of the subject matter described in this disclosure, there is provided a system. The system includes a plurality of users of a network having one or more certified products or services. The system, which in reference to certain embodiments is referred to as a certification management system, receives requests from the users regarding managing the one or more certified products or services. The certification management system is configured to track a plurality of transactions involving purchases of the one or more certified products or services. Also, the certification management is configured to collect proceeds involving the transactions of the one or more certified products or services to be distributed to one or more partners. The transactions of the one or more certified products or services are captured in a blockchain for transparency.

In some embodiments, a method is provided of generating measurable social impact. The method comprises the steps of: receiving, at a server, a request for access from a first computing device; sending, to the first computing device, a first request, wherein the first request comprises a membership application; receiving, at the server, from the first computing device, the membership application; approving the membership application; storing, at a database associated with the server, a set of terms and conditions; retrieving, from the database associated with the server, the set of terms and conditions; upon approval of the membership application, allowing access, by the first computing device, to the set of terms and conditions, receiving, at the server, from the first computing device, at least one first user input; accepting, at the server, the set of terms and conditions based on the at least one first user input; generating, at the server, a member account, wherein the member account is based on at least one of the membership application or at least one second user input received, at the server, from the first computing device; automatically executing, at the server, a transaction, wherein the transaction comprises: executing a purchase of at least one good or service, wherein the at least one good or service is associated with a social impact partner; collecting a purchase amount of the transaction; sending, to a second computing device, at least a portion of the purchase amount of the transaction, wherein the second computing device is associated with the social impact partner; and capturing the transaction in a first blockchain record on a first blockchain. The method further comprises automatically executing, at the server, the capture of a receipt of the at least a portion of the purchase amount of the transaction at the second computing device, wherein the receipt is captured in a second blockchain record on the first blockchain.

In some embodiments, a copy of the set of terms and conditions is sent to the first computing device upon the accepting of the set of terms and conditions.

In some embodiments, membership information is generated, and the membership information is sent to a database, wherein the membership information is stored at the database.

In some embodiments, a second user input is received from the first computing device, wherein the second user input comprises login information, and a login result is generated at the server based on the validity of the login information.

In some embodiments, at least one good or service is associated with a certification.

In some embodiments, at least one custom code is generated, wherein the custom code is used to identify that the at least one good or service has the certification.

In some embodiments, the custom code is transmitted to at least one of the first computing device, the second computing device, or a third computing device, wherein the custom code allows for the automatic display of the at least one good or service on a display of the first computing device, the second computing device, or a third computing device.

In some embodiments, the custom code is a QR code.

In some embodiments, the transaction comprises transaction data.

In some embodiments, transactions comprising transaction data comprise identifying a first set of factors based on the transaction data, wherein the first set of factors includes at least one of a country, a local economy, fuel cost, labor cost, or raw material cost, and varying the at least a portion of the purchase amount of the transaction according to the first set of factors.

In some embodiments, the purchase of the at least one good or service comprises exchanging at least one cryptocurrency token, fungible token, or non-fungible token, for at least one good or service.

In some embodiments, the second blockchain record is captured on a second blockchain.

In some embodiments, there is a confirmation of the first blockchain record and the second blockchain record, and at least one of the first blockchain record or the second blockchain record are stored on a second blockchain.

In some embodiments, a method is provided of generating measurable social impact. The method comprises: receiving, at a server, a request for access from a first computing device; sending, to the first computing device, a first request; receiving, at the server, from the first computing device, the first request; storing, at a database associated with the server, a set of terms and conditions; retrieving, from the database associated with the server, the set of terms and conditions; allowing access, by the first computing device, to the set of terms and conditions; receiving, at the server, from the first computing device, at least one first user input; accepting, at the server, the set of terms and conditions based on the at least one first user input; generating, at the server, a member account, wherein the member account is based on at least one of the first request or at least one second user input received, at the server, from the first computing device, and wherein the member account comprises a social impact wallet, wherein the member account allows access, by the first computing device, to the social impact wallet; automatically executing, at the server, a transaction, wherein automatically executing the transaction comprises: executing a purchase of at least one good or service, wherein the purchase is executed by the social impact wallet, and wherein the at least one good or service is associated with a social impact partner; collecting a purchase amount of the transaction; sending, to a second computing device, at least a portion of the purchase amount of the transaction, wherein the second computing device is associated with the social impact partner; and capturing the transaction in a first blockchain record on a first blockchain. The method further comprises automatically executing, at the server, the capture of a receipt of the at least a portion of the purchase amount of the transaction at the second computing device, wherein the receipt is captured in a second blockchain record; and generating, at the social impact wallet, an award based on at least one of the transaction or one or more transaction milestones achieved by completing the transaction.

In some embodiments, the social impact wallet allows for the exchange of at least one cryptocurrency token, fungible token, or non-fungible token.

In some embodiments, the social impact wallet has an associated transaction fee.

In some embodiments, the associated transaction fee is collected and sent to the second computing device.

In some embodiments, the award based on the at least one of the transaction or the one or more transaction milestones achieved by completing the transaction is at least one of a cryptocurrency token, fungible token, non-fungible token, digital asset, or digital asset representative of a physical asset.

In some embodiments, the social impact wallet comprises a social profile, wherein the social profile is associated with the social impact wallet and the member account, and wherein the social profile may be managed through an interface of the first computing device communicatively coupled with the social impact wallet.

In some embodiments, a system is used to generate measurable social impact. The system comprises: a server, the server comprising: a memory comprising server instructions and a processing device configured for executing the server instructions, wherein the server instructions cause the processing device to perform operations of: receiving, at a server, a request for access from a first computing device; sending, to the first computing device, a first request, wherein the first request comprises a membership application; receiving, at the server, from the first computing device, the membership application; approving the membership application; storing, at a database associated with the server, a set of terms and conditions; retrieving, from the database associated with the server, the set of terms and conditions; upon approval of the membership application, allowing access, by the first computing device, to the set of terms and conditions; receiving, at the server, from the first computing device, at least one first user input; accepting, at the server, the set of terms and conditions based on the at least one first user input; generating, at the server, a member account, wherein the member account is based on at least one of the membership application or at least one second user input received, at the server, from the first computing device; automatically executing, at the server, a transaction, wherein automatically executing the transaction comprises: executing a purchase of at least one good or service, wherein the at least one good or service is associated with a social impact partner; collecting a purchase amount of the transaction; sending, to a second computing device, at least a portion of the purchase amount of the transaction, wherein the second computing device is associated with the social impact partner; and capturing the transaction in a first blockchain record on a first blockchain. The system further comprises the processing device performing the operations of: automatically executing, at the server, the capture of a receipt of the at least a portion of the purchase amount of the transaction at the second computing device, wherein the receipt is captured in a second blockchain record on the first blockchain.

Additional features and advantages of the present invention are described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion. Further, some components may be omitted in certain figures for clarity of discussion.

FIG. 1 is a workflow illustrating the operation of an exemplary certification management system, in accordance with some embodiments.

FIG. 2 is a high-level network system for accessing and managing certification information, in accordance with some embodiments.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

This disclosure describes a certification management system that aims to help socially responsible and conscious companies make a positive social impact by providing a cost-efficient way for customers to give back, thus enhancing the integrity and value of a brand. The certification management system may utilize a certification that can be used on a user's product and/or service to show their social impact clearly. The user may assign any number of certificates to a particular product or service, and there are at least two ways to participate in the certification management system: 1.) Choose a custom monthly subscription that can be changed as needed to reflect the actual number of units sold of a particular product or service assigned the certification; OR 2.) Purchase the certification in bulk and attribute them across an entire product/service line, choosing how you want to offer them to your customers to entice their business. In both cases, the user may agree to a contractual agreement to use the certification and a QR code in their marketing.

Once payment is received, the certification management system may immediately send funds to one or more charity partners to deliver the collected contributions. When the funds are provided, the user may receive a notification from the certification management system when the funds have been received and used by the charity partner to deliver the social outputs. Also, the user's certified products or services may be automatically displayed on a website via a custom code the certification management system provides to the user, which includes a QR code that customers can scan to verify the social impacts claimed by the company. Furthermore, all transactions may be captured in a blockchain, such as EOS blockchain or the like, for transparency. Moreover, customers may receive a custom snippet of code that can display a user's accumulated social impact on their website, as well as on their user's profile page on the certification management system.

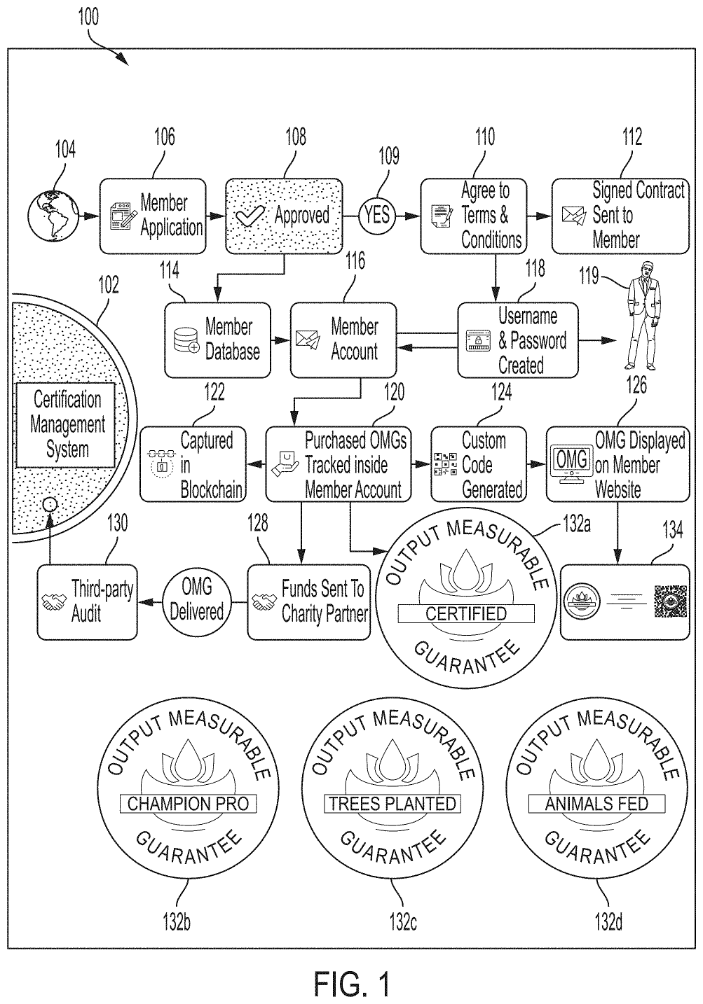

FIG. 1 is a schematic diagram illustrating a workflow 100 of the certification management system 102, in accordance with some embodiments. The certification management system 102 may be a cloud server or data server managing all aspects as shown in FIG. 1. In some embodiments, the certification management system 102 may receive requests or messages from a plurality of licensed users to use the certification management system 102. A user may access the certification management system 102 using the Internet or a network 104. Before the user accesses the certification management system 102, the user may be required to fill out a membership application, as shown in block 106. Once the membership application has been completed, the certification management system 102 may approve or deny the user's membership application, as shown in block 108. If the membership application has been approved, as shown in block 109, the user may accept the terms and conditions specified in the license for using the certification management system 102, as shown in block 210. Once the acceptance is received by the certification management system 102, the certification management system 102 may send a copy of the signed contract to the user, as shown in block 112.

In some embodiments, the user may be a company or an individual. In some embodiments, the membership application may be an online membership application filled out by the user. In some embodiments, the membership application may be paper-based, later filled out, scanned, and sent to the certification management system 102.

In some embodiments, the formal signature may be a digital e-signature. A photograph sent to the certification management system 102 showing a signed contract may be sufficient to establish the formal signature in some embodiments.

At block 114, the user's information may be sent to a member database once the membership has been approved. Also, the certification management system 102 may create a member account associated with a user 119, as shown in block 116. The member account may include information derived from the certification management system 102, including the user 119 providing a username and password for the member account, as shown in block 118.

At block 120, certification management system 102 may track the social outputs for products having certifications 132a-132d as defined by user 119. The certification management system 102 may collect the money generated from the purchased goods. Moreover, the transactions associated with the purchased goods are captured in a first blockchain, such as an EOS blockchain or the like, for transparency, as shown in block 122. At block 124, the certification management system 102 may generate a custom code to identify which user's products or services are certified. At block 126, the user's certified products or services may be automatically displayed on a website via the custom code, which includes a QR code that customers of these certified users can scan to confirm the user's certified products, as shown in block 134.

From these purchases, a set amount is directly sent to one or more charity partners to deliver the social output (feeding a child, feeding a rescued animal, or planting a tree), as shown in block 128. This is called the Charity Output Fees (COF), which may vary depending on the cost to the charity partner and factors that may include local economy, fuel, labor, and raw material costs. It is important to note that the COF can vary tremendously from country to country. In addition, an auditor oversees each of these transactions to ensure the transparency of the certification management system 102, as shown in block 130. In some implementations, an additional blockchain record may be used when the charity partner receives the funds from certification management system 102 to deliver the social outputs.

In some implementations, certification management system 102 may manage cryptocurrency tokens. The Ethereum (ETH) and Binance Smart Chain (BSC) Blockchains may simultaneously sell the cryptocurrency tokens. The certification management system 102 may allow users to have a Social Impact wallet. In this case, all users using the cryptocurrency tokens described herein must have a Social Impact Wallet indicating their social impact. Transactions of all cryptocurrency tokens held by users in their respective Social Impact wallets may have a fee that may be converted to social impact. However, it all depends on the cryptocurrency token traded. The user may also have a profile showing the cumulative social impact they have made. Moreover, the certification management system 102 may gamify these social impacts, awarding unique non-fungible tokens (NFTs) or even real-world prizes to the Social Impact wallet users once they reach social impact milestones. The Social Impact wallet may be interactive to use, and engagement is critical to the success of this platform. In some implementations, a social impact debit card may be an extension of the Social Impact Wallet. When a user pays for products with this social impact debit card a portion of the payment processing fees may also be converted to social outputs.

In some implementations, certification management system 102 may manage the exchange of cryptocurrency tokens. The certification management system 102 may attach transaction fees to the buying or selling of the cryptocurrency tokens, which may be converted into social impacts. However, any cryptocurrency token traded may also have a payment processing fee which may be partially converted to measurable social impacts. There may be gamification of the social impact of each individual. The fees collected may be distributed on a timely basis to charity partners to deliver the outputs and pay for the certification and upkeep of the exchange.

In this case, each user has a profile that displays their respective social impact that can be shared with friends and gamify through rewarding specific giving levels. These public profiles would not show the holdings or how much money the user has but would display how much social impact they have made. So even if they are not active users, it would still show that they're making a positive social impact. The social profile may include a custom avatar the user creates so that their real identity is hidden. Also, the certification management system 102 may include a rating system of other cryptocurrency tokens. The rating system may be based on an algorithm that may help users identify potential “rug pulls” from legitimate cryptocurrency tokens.

In some embodiments, the cryptocurrency tokens managed by the certification management system 102 are certified. All donations made to charity partners may be confirmed by the certification management system 102 and recorded in a second blockchain, such as an EOS blockchain or the like, for transparency.

In some embodiments, the certification management system 102 may provide plugins for existing payment systems to expand the architecture where users can transact cryptocurrency tokens. These plugins may also allow the cryptocurrency tokens to be an accepted form of payment. In addition, the plugins may provide access to users, customers, and participating companies to earn cryptocurrency tokens. This would encourage adoption and increase the value of the cryptocurrency tokens.

In some embodiments, the charity partner may receive the donated funds through a digital transaction service, such as PayPal. As previously described, the donation receipts are recorded to the blockchain.

In some embodiments, the certification management system may include a web interface, such as a web site, communicatively coupled directly to a server or over a network to a server. The web interface may be accessible via a plurality of user devices including, but not limited to, laptop computers, desktop computers, and/or mobile phones.

In some implementations, the certification management system or its web interface may include one or more content management systems or plugins. The content management systems or plugins may be any combinations of licensed, open-source, or custom software. The content management system and plugins may be used for functions including billing users, managing purchase orders, managing user roles and public directories, linking orders to the member-user, connecting an order with the appropriate blockchain, and communications with the blockchain. In some embodiments, the plugins may use cryptographic keys to sign the transaction to be published to the blockchain. In some embodiments, a custom plugin utilizes a private code to sign the transaction to be published to the blockchain. In some embodiments, a smart contract is used in conjunction with the blockchain to automatically publish a transaction to the blockchain.

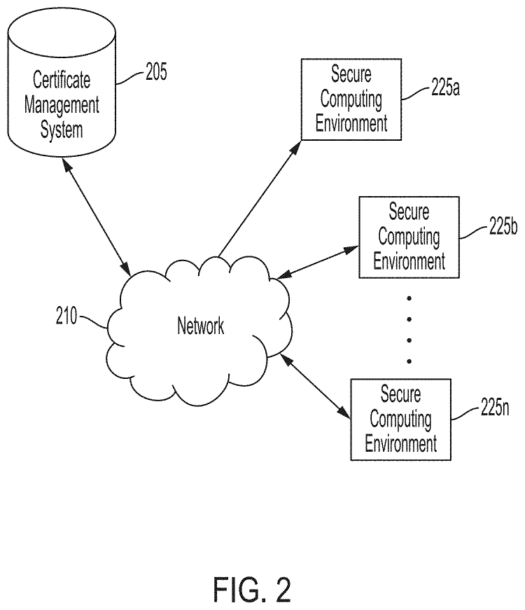

Illustrated in FIG. 2 is a high level network system 200 that may include interfaces that access, maintain, analyze, and display structured data. In the depicted implementation, the system 200 may include a certification management system 205 communicatively coupled to a plurality of secure computing environments 225 via the network 210 to perform the operations of workflow 100. Note the certification management system 205 may be similar to the certification management system 102 of FIG. 1. While a single certification management system 205 is illustrated, the disclosed principles and techniques could be expanded to include multiple certification management systems 205.

The certification management system 205, according to some embodiments, is configured to store a plurality of structured data in a secure environment requiring authentication before access is granted to the structured data. According to one implementation, the structured data may include membership and certification information of a user including other operational information described herein to perform workflow 100. In some cases, the structured data in the certification management system 205 may be sourced or obtained from third-party sources or the like.

In addition, certification management system 205 may be configured to manage or otherwise maintain the integrity of the structured data so that a user (e.g., a user of the secure computing environment) does not have to deal with such data maintenance processes as the structured data changes and/or grows. In one embodiment, the certification management system 205 may provide the most current version of the structured data to a user of the system. Furthermore, certification management system 205 may include mechanisms that execute operations of data decompression operations, data decryption operations, and data decoding operations associated with the structured data so that the user is effectively isolated from such operations.

The certification management system 205 may be implemented within a computing device such as a mainframe server, a content server, a communication server, a laptop computer, a desktop computer, a handheld computing device, a virtual machine, a cloud-based computing solution and/or service, and/or the like. The certification management system 205 may include a plurality of computing devices configured to communicate with one another and/or implement the techniques described herein. In some instances, the certification management system 205 may include various elements of a computing environment. For example, certification management system 205 may include a processing system, a memory, an input/output (I/O) system, and a communication system. A user may operate/maintain the certification management system 205 either locally or remotely as the case may require.

The certification management system 205 may be configured to have storage logic that is executable to store structured data that is shared across multiple secure computing environments 225. According to one implementation, certification management system 205 may include a plurality of non-volatile/non-transitory storage media such as solid state storage media, hard disk storage media, virtual storage media, cloud-based storage drives, storage servers, and/or the like. The plurality of storage media may be configured to store data from a plurality of sources. For example, certification management system 205 may include storage logic that is executable to store structured data derived from, for example, medical data, research data, education data, government data, etc.

According to some implementations, the storage logic of the certification management system 205 may be configured to automatically monitor and/or update relevant structured data obtained from a third-party source. For example, the storage logic of the certification management system 205 may periodically monitor updates associated with structured data from third-party organizations/sources and automatically update different versions of the structured data within one or more storage media of the certification management system 205. In one embodiment, the storage logic of the certification management system 205 manipulates or otherwise formats the structured data such that user interfaces generated by a secure computing environment 225 can seamlessly access/retrieve and present the structured data to a user. In addition, structured data from the certification management system 205 may be accessed on a regulated basis via credential access, for example. This regulated basis may be determined, in part, by licenses, privileges, and other levels of authorization dictated by a user's credentials.

As previously discussed, the network 210 facilitates communication between the certification management system 205 and the secure computing environment 225. The network 210 may also allow different secure computing environments 225 to communicate with each other. According to one embodiment, the network 210 may include a plurality of networks. For instance, the network 210 may include any wired/wireless communication network that facilitates communication between the components of the network system 200. The network 210, in some instances, may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a fiber optics network, a laser-based network, and/or the like.

The secure computing environment 225 may include one or more interfaces for accessing, analyzing, and displaying the structured data. According to some implementations, the secure computing environment 225 may include functionalities and/or enhanced security features that allow a user to securely access and/or securely manage structured data. In addition, the secure computing environment 225 may include a processing system, a memory, and I/O system, and a communication system. The processing system, the memory, the I/O system, and the communication system may include one or more subsystems that perform one or more of the operations described herein. Additionally, each system of the secure computing environment 225 may be operatively and/or otherwise communicatively coupled with each other so as to facilitate one or more operations described herein. The secure computing environment 225 may include general hardware, specifically-purposed hardware, and/or a combination thereof.

This application claims the benefit of, and priority to, U.S. Provisional Patent Application No. 63/234,032, filed Aug. 17, 2021, which is incorporated by reference herein in its entirety for all purposes.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Implementation of any device or unit or element of any apparatus or device described herein is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages. Any features or embodiments described herein may be combined or integrated with any other features or embodiments described herein. Any feature associated with or comprised in one or more embodiments may be associated with or comprised in one or more other embodiments. In some embodiments, any features associated with or described as being performed in blockchain ecosystems can additionally or alternatively be performed in non-blockchain networks such as wired, wireless, and/or cloud networks.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A method of generating measurable social impact, comprising:
receiving, at a server, a request for access from a first computing device;
sending, to the first computing device, a first request, wherein the first request comprises a membership application;
receiving, at the server, from the first computing device, the membership application;
approving the membership application;
storing, at a database associated with the server, a set of terms and conditions;
retrieving, from the database associated with the server, the set of terms and conditions;
upon approval of the membership application, allowing access, by the first computing device, to the set of terms and conditions;
receiving, at the server, from the first computing device, at least one first user input;
accepting, at the server, the set of terms and conditions based on the at least one first user input;
generating, at the server, a member account, wherein the member account is based on at least one of the membership application or at least one second user input received, at the server, from the first computing device;
automatically executing, at the server, a transaction, wherein automatically executing the transaction comprises:
executing a purchase of at least one good or service, wherein the at least one good or service is associated with a social impact partner;
collecting a purchase amount of the transaction;
sending, to a second computing device, at least a portion of the purchase amount of the transaction, wherein the second computing device is associated with the social impact partner; and
capturing the transaction in a first blockchain record on a first blockchain; and
automatically executing, at the server, the capture of a receipt of the at least a portion of the purchase amount of the transaction at the second computing device, wherein the receipt is captured in a second blockchain record on the first blockchain.

2. The method of claim 1, further comprising:
sending, upon accepting, at the server, the set of terms and conditions, to the first computing device, a copy of the set of terms and conditions.

3. The method of claim 1, further comprising:
generating, at the server, membership information based on the membership application; and
sending, to the database associated with the server, the membership information, wherein the membership information is stored at the database associated with the server.

4. The method of claim 1, further comprising:
receiving, from the first computing device, a second user input, wherein the second user input comprises login information; and
generating, at the server, a login result based on the validity of the login information.

5. The method of claim 1, further comprising:
associating, at the server, the at least one good or service with a certification.

6. The method of claim 5, further comprising:
generating, at the server, at least one custom code, wherein the custom code is used to identify that the at least one good or service has the certification.

7. The method of claim 6, further comprising:
transmitting, to at least one of the first computing device, the second computing device, or a third computing device, the custom code, wherein the custom code allows for the automatic display of the at least one good or service on a display of the first computing device, the second computing device, or a third computing device.

8. The method of claim 6, wherein the at least one custom code is a QR code.

9. The method of claim 1, wherein the transaction comprises transaction data.

10. The method of claim 9, further comprising:
identifying, at the server, a first set of factors based on the transaction data, wherein the first set of factors includes at least one of a country, a local economy, fuel cost, labor cost, or raw material cost;
varying, at the server, the at least a portion of the purchase amount of the transaction according to the first set of factors;

11. The method of claim 1, wherein the purchase of the at least one good or service comprises exchanging at least one cryptocurrency token, fungible token, or non-fungible token, for the at least one good or service.

12. The method of claim 1, wherein the second blockchain record is captured on a second blockchain.

13. The method of claim 1, further comprising:
confirming, at the server, the first blockchain record and the second blockchain record; and
storing, on a second blockchain, at least one of the first blockchain record or the second blockchain record.

14. A method of generating measurable social impact, comprising:
receiving, at a server, a request for access from a first computing device;
sending, to the first computing device, a first request;
receiving, at the server, from the first computing device, the first request;
storing, at a database associated with the server, a set of terms and conditions;
retrieving, from the database associated with the server, the set of terms and conditions;
allowing access, by the first computing device, to the set of terms and conditions;
receiving, at the server, from the first computing device, at least one first user input;
accepting, at the server, the set of terms and conditions based on the at least one first user input;
generating, at the server, a member account, wherein the member account is based on at least one of the first request or at least one second user input received, at the server, from the first computing device, and wherein the member account comprises a social impact wallet, wherein the member account allows access, by the first computing device, to the social impact wallet;
automatically executing, at the server, a transaction, wherein automatically executing the transaction comprises:
executing a purchase of at least one good or service, wherein the purchase is executed by the social impact wallet, and wherein the at least one good or service is associated with a social impact partner;
collecting a purchase amount of the transaction;
sending, to a second computing device, at least a portion of the purchase amount of the transaction, wherein the second computing device is associated with the social impact partner; and
capturing the transaction in a first blockchain record on a first blockchain; and
automatically executing, at the server, the capture of a receipt of the at least a portion of the purchase amount of the transaction at the second computing device, wherein the receipt is captured in a second blockchain record; and
generating, at the social impact wallet, an award based on at least one of the transaction or one or more transaction milestones achieved by completing the transaction.

15. The method of claim 14, wherein the social impact wallet allows for the exchange of at least one cryptocurrency token, fungible token, or non-fungible token.

16. The method of claim 14, where the social impact wallet has an associated transaction fee.

17. The method of claim 16, further comprising:
collecting the associated transaction fee; and
sending, to the second computing device, the associated transaction fee.

18. The method of claim 14, wherein the award based on the at least one of the transaction or the one or more transaction milestones achieved by completing the transaction is at least one of a cryptocurrency token, fungible token, non-fungible token, digital asset, or digital asset representative of a physical asset.

19. The method of claim 14, wherein the social impact wallet comprises a social profile, wherein the social profile is associated with the social impact wallet and the member account, and wherein the social profile may be managed through an interface of the first computing device communicatively coupled with the social impact wallet.

20. A system used to generate measurable social impact, comprising:
a server, the server comprising:
a memory comprising server instructions; and
a processing device configured for executing the server instructions, wherein the server instructions cause the processing device to perform operations of:
receiving, at a server, a request for access from a first computing device;
sending, to the first computing device, a first request, wherein the first request comprises a membership application;
receiving, at the server, from the first computing device, the membership application;
approving the membership application;
storing, at a database associated with the server, a set of terms and conditions;
retrieving, from the database associated with the server, the set of terms and conditions;
upon approval of the membership application, allowing access, by the first computing device, to the set of terms and conditions;
receiving, at the server, from the first computing device, at least one first user input;
accepting, at the server, the set of terms and conditions based on the at least one first user input;
generating, at the server, a member account, wherein the member account is based on at least one of the membership application or at least one second user input received, at the server, from the first computing device;
automatically executing, at the server, a transaction, wherein automatically executing the transaction comprises:
executing a purchase of at least one good or service, wherein the at least one good or service is associated with a social impact partner;
collecting a purchase amount of the transaction;
sending, to a second computing device, at least a portion of the purchase amount of the transaction, wherein the second computing device is associated with the social impact partner; and
capturing the transaction in a first blockchain record on a first blockchain; and
automatically executing, at the server, the capture of a receipt of the at least a portion of the purchase amount of the transaction at the second computing device, wherein the receipt is captured in a second blockchain record on the first blockchain.
